(19) United States
(12) Patent Application Publication
(10) Pub. No.: US 2006/0164382 A1
(43) Pub. Date: Jul. 27, 2006

(54) Image manipulation in response to a movement of a display

(75) Inventors: Charles J. Kulas, San Francisco, CA (US); Daniel Remer, Nicasio, CA (US)

Correspondence Address: Charles J. Kulas, 651 Orizaba Ave., San Francisco, CA, 94132, US

(73) Assignee: Technology Licensing Company, Inc., San Francisco, CA (US)

(21) Appl. No.: 11/043,290

(22) Filed: Jan. 25, 2005

(51) Int. Cl. G09G 5/00

(52) U.S. Cl. 345/156

(57) ABSTRACT

A handheld device includes a position sensor for sensing movement of the device's display screen relative to another object. A user of the device is able to vertically or horizontally move an image within the display screen by moving or positioning the device in space. An image can also be zoomed in or out by bringing the device and display screen closer to or farther from the user. The user can switch between a motion mode of panning and zooming or a non-motion mode where moving the device does not cause the image on the display screen to move. This allows the motion mode to be used with traditional forms of image manipulation and item selection using a pointer and “click” button. Function, sensitivity, calibration and other options for configuring controls and motion sensing are provided so that the translation of a motion of the device to a manipulation of the image on the screen can be modified to suit different user desires, or different applications or functions. Another approach performs device movement by using an external sensor, such as a camera, and providing image translation information to the device. User gestures while holding the device can be used to invoke device commands such as selecting an item, going back a page in a web browser, etc.

### BACKGROUND OF THE INVENTION

Small communication and computation devices such as cell phones, personal digital assistants (PDAs), Blackberry, pentop, laptop, ultra-portable, and other devices provide convenience to a user because their small size allows them to be used as mobile devices, or to occupy less space in a home, office or other setting. However, a problem with such small devices is their tiny displays can be too small to conveniently allow the user to read a web page, map or other image.

One prior art approach uses a “joystick” or other directional control to allow a user to pan an image horizontally or vertically within a display screen. This approach can be cumbersome as the small control is manipulated with a user's finger or thumb in an “on/off” manner so that the control is either activated in a direction, or not. With the small display and miniature images presented on a small screen, many brief and sensitive movements of the control may be needed to position a pointer over a desired location on the display screen, or to pan or scroll information on the display screen to a desired spot. Using this approach a user can lose context and may no longer know what part of the image he or she is viewing. This is particularly aggravating when attempting to read spreadsheets, word processing documents or when viewing high resolution images or detailed web pages.

### SUMMARY OF THE INVENTION

One embodiment of the invention provides a handheld device with a sensor for sensing movement of the device's display screen in space, or relative to another object. A user of the device is able to vertically or horizontally move an image within the display screen by moving or positioning the device in space. An image may also be zoomed in or out by bringing the device and display screen closer to or farther from the user. In one embodiment, a button control on the device allows a user to switch between a motion mode of panning and zooming where manipulation of the device in space causes movement of an image on the display screen, or a non-motion mode where moving the device does not cause the image on the display screen to move. This allows the motion mode to be used with traditional forms of image manipulation and item selection using a pointer and “click” button.

A user can select a stationary pointer and place the device into a motion mode so that an image can be moved to bring an item in the image under the pointer for selection. Function, sensitivity, calibration and other options for configuring controls and motion sensing are provided so that the translation of a motion of the device to a manipulation of the image on the screen can be modified to suit different user desires, or different applications or functions. Other features are disclosed.

In one embodiment the invention provides an apparatus for manipulating an image, the apparatus comprising: a display screen coupled to a housing; a sensor coupled to the housing, wherein the sensor provides information on a movement of the display screen; a translation process for translating a signal from the sensor into a change in an image displayed on the display screen.

In another embodiment the invention provides a method for manipulating an image on a display screen, the method comprising: determining a movement in space of the display screen; and changing the image on the display screen in accordance with the movement in space of the display screen.

In another embodiment the invention provides a machine-readable medium including instructions executable by a processor for manipulating an image on a display screen, the machine-readable medium comprising: one or more instructions for determining a movement in space of the display screen; and one or more instructions for changing the image on the display screen in accordance with the movement in space of the display screen.

In another embodiment, the user can go into document mode so that lines of text at a comfortable size can be scrolled or panned across the device's screen using movements of the entire device as the user interface. In this embodiment, once the comfortable size is selected, the user by moving the device will cause the image to be displayed via movement of the device in one special plane.

In another embodiment, the user can explore a map or an image and through movement of the device in a free-form fashion can indicate a direction. In this embodiment, the device is treated as a steering wheel. The device will display or reveal the image in the direction indicated by the user by moving the device in that direction. If the direction changes, for example if a road on a map makes a left hand turn, the user will at the turn move the device to the left as if steering it with an automobile steering wheel and the image or map will begin to reveal itself in the new direction.

In another embodiment the device can be placed on a flat surface such as a table and moved as a computer mouse is moved. The amount of movement may be a small or as large as the user is comfortable with and will automatically be calibrated to an appropriate movement of the image.

In another embodiment, a mouse input device is equipped with a display screen that includes display movement translation. As the mouse is moved over a surface an image on the display is manipulated in a manner corresponding to the mouse movement.

### BRIEF DESCRIPTION OF THE DRAWINGS

FIG. 1 illustrates a cell phone device, exemplary of a device that can be used with the invention;

FIG. 2 defines positions and directions for describing the effects of movement of a display screen upon an image shown on the display screen;

FIG. 3 shows a web page and display viewing area;

FIG. 4 shows a viewable image portion with the display screen moved up from its starting point

FIG. 5 shows a display screen image at a starting point;

FIG. 6 shows the viewable image portion with the display screen moved down from its starting point;

FIG. 7 shows the viewable image portion with the display screen moved to the right of its starting point;

FIG. 8 shows the viewable image portion with the display screen moved to the left of its starting point;

FIG. 9 shows the viewable image portion with the display screen moved inward, or towards the user's viewpoint;

FIG. 10 shows the viewable image portion with the display screen moved outward, or away from the user's viewpoint;

FIG. 11 illustrates a viewable image portion when the display screen is rotated;

FIG. 12 illustrates selection of an item according to an embodiment of the invention where a stationary screen-centered pointer is used; and

FIG. 13 provides a basic block diagram of subsystems in an embodiment of the invention.

### DETAILED DESCRIPTION OF THE INVENTION

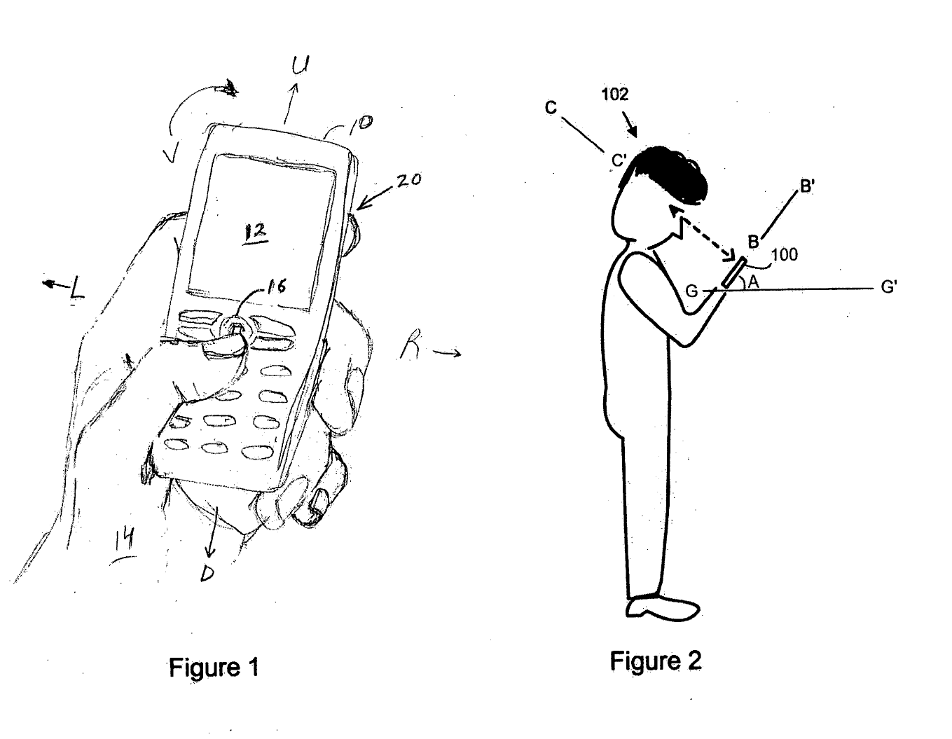

FIG. 1 illustrates a mobile phone device, exemplary of a device that can be used with the invention. Note that various aspects of the invention can be used with any type of device such as a mobile phone, PDA, pentop, laptop, Blackberry™, computer game device, portable music (e.g., mp3) player, navigation system, or even a computer mouse with a small built in display, etc.

In FIG. 1, screen display 12 is included in mobile phone 10. A user's hand 14 holds the mobile phone. The user's thumb is used to push a directional control 16 to move an image on the display screen. In the example of FIG. 1, directional control 16 is a nub, or small protrusion, similar to a small joystick, that can be moved either up, down, right or left, or depressed downward—into the mobile phone. Naturally, any other type of user input controls can be used to move the image. For example, a paddle, joystick, pad, buttons, keys, disc, touch screen, etc. can be used. Combinations of different controls can be used. Other control technology, such as voice, or even pressure on the device itself (a squeezable device) can be employed.

FIG. 1 also illustrates several movement or motion directions of the handheld display on the cell phone with respect to a user's viewpoint. For example, the user can move the display to the left in the direction “L,” to the right in the direction “R,” upwards in the direction “U,” downwards in the direction “D,” or rotate clockwise in a direction “V” or counterclockwise in a direction opposite to V. Although not shown with symbols, the user can also move the display “inward,” towards the user (i.e., so the distance between the display and the user's eyes is decreased) or “outward,” away from the user (i.e., so that the distance between the display and the user's eyes is increased). Movements in other directions are possible. Movement need not be precise or especially accurate to achieve desired panning or zooming the display. The coordination and calibration of a movement's effect on an image displayed on the display screen can be predetermined, modified or adjusted as desired.

FIG. 2 defines positions and directions that are useful in describing the effects of movement of a display screen on image panning and zooming in a preferred embodiment of the invention. In FIG. 2, user 102 is shown in a side view. User 102 moves display screen 100 (e.g., a display screen attached to a cell phone or other device) up along the direction B-B′ or down along the direction B′-B. Movement inward or towards the user is in the direction C′-C and movement outward or away from the user is in the direction C-C′. Movement to the user's right is normal to the plane containing B-B′ and C-C′ and is outward from the page. Movement to the user's left is opposite to the rightward movement. The angle “A” is the angle of the display screen with respect to G-G′ that approximates a flat surface upon which the user is standing.

Note that various movements can be with respect to any reference point. In a preferred embodiment the reference point is a user's viewpoint (i.e., position of the user's eyes) but, as will be discussed below, other reference points are possible. Also, different user's or different devices may operate, hold, or move a display screen in different ways. In general, features of the invention can be modified as desired to work with different specific orientations, movements, devices or mannerisms. For example, some users may not hold a display screen at the (approximate) 45 degree angle, A, shown in FIG. 2. Or a user may be working with a device on a tabletop, floor or other surface so that A is effectively 0. In this case the user may not be moving the device at all, but the user may be moving his or her head in order to change the reference position of the device in one or more directions. Other variations are possible.

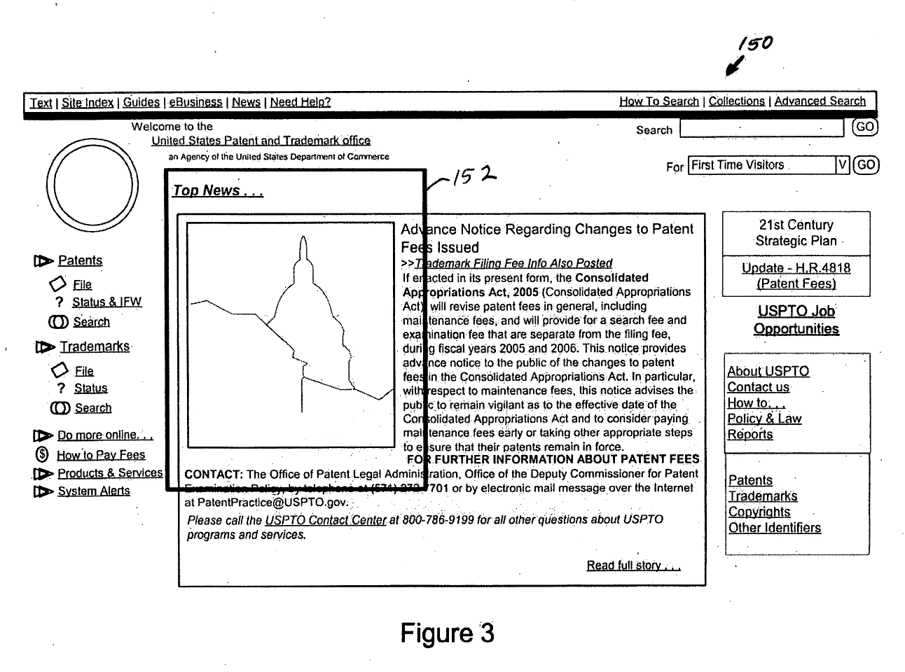

FIG. 3 shows a web page 150 and viewing area 152. In FIG. 3, the current resolution and size of a representation of web page 150 are such that only the portion of the web page within viewing area 152 is visible on a display screen being manipulated by a user. In other words, the user is only able to see the text “Top News . . . ”, the image and fragments of text surrounding the image. In FIG. 3, underlined text indicates a hyperlink to other content. In general, features of the invention can be used to advantage to view any type of visual content or media including pictures, video, three-dimensional objects, etc. The display functions of the present invention may be especially advantageous when the image to be displayed is significantly larger than the size of the display window. As discussed below, as the user moves the display screen different parts of the web page that are not visible will come into view. For illustrative purposes, a helpful way to visualize the effect of the panning motion is to imagine that viewing area 152 is being moved like a small window over the surface of web page 150.

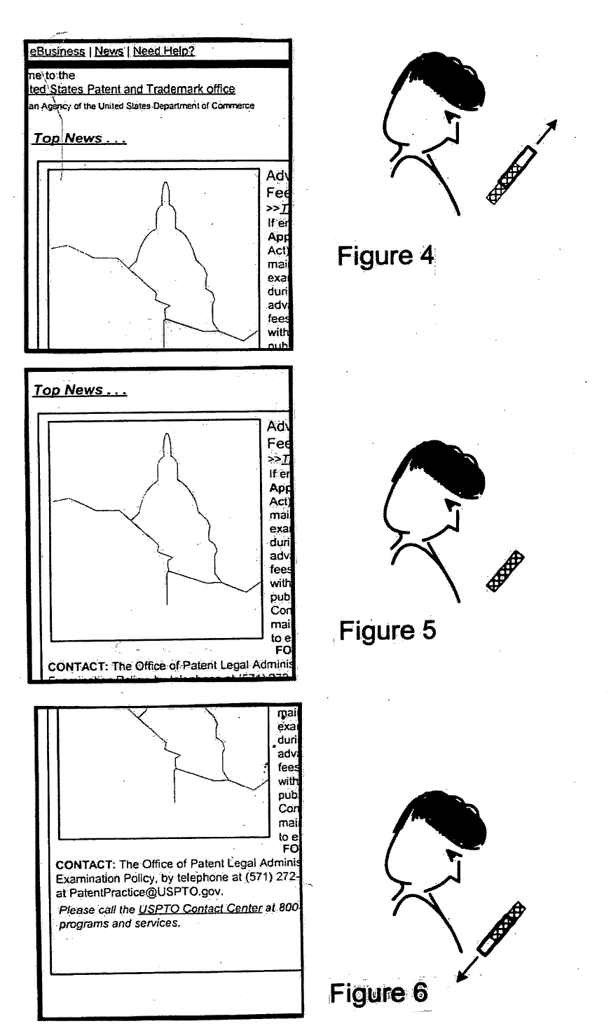

FIGS. 4-10 show an effect on the viewable portion of the image by moving the display screen up, down, right, left, inward or outward.

FIG. 5 shows the image at a starting point. The viewing area is the same as in FIG. 3 and any arbitrary starting point can be used. A starting point may be obtained, for example, when a user first selects a web page. A default viewing area for the web page can be set by a web page designer, by a processor doing display processing to the display screen, or by other approaches. In a preferred embodiment, the user is able to turn a motion mode of panning and zooming on or off. Standard controls, such as a touch screen, joystick, etc., can be used to manipulate an image to a starting point and then a motion mode of panning and zooming can be selected, for example, by depressing a button at the back of the device (e.g., at 20 in FIG. 1) located conveniently under the user's index finger. In other embodiments, any other control or way of establishing a starting point for a motion mode of operation can be used. For example, the motion mode can be triggered by speech recognition, by shaking the device, after a time interval, after a web page has loaded, when predetermined content (e.g., an image) is accessed, etc.

FIG. 4 shows the viewable image portion with the display screen moved up from its starting point. To the right of the display screen is a diagram depicting the motion of the display screen with respect to the user's viewpoint. The starting position of the display screen is shown as a shaded rectangle.

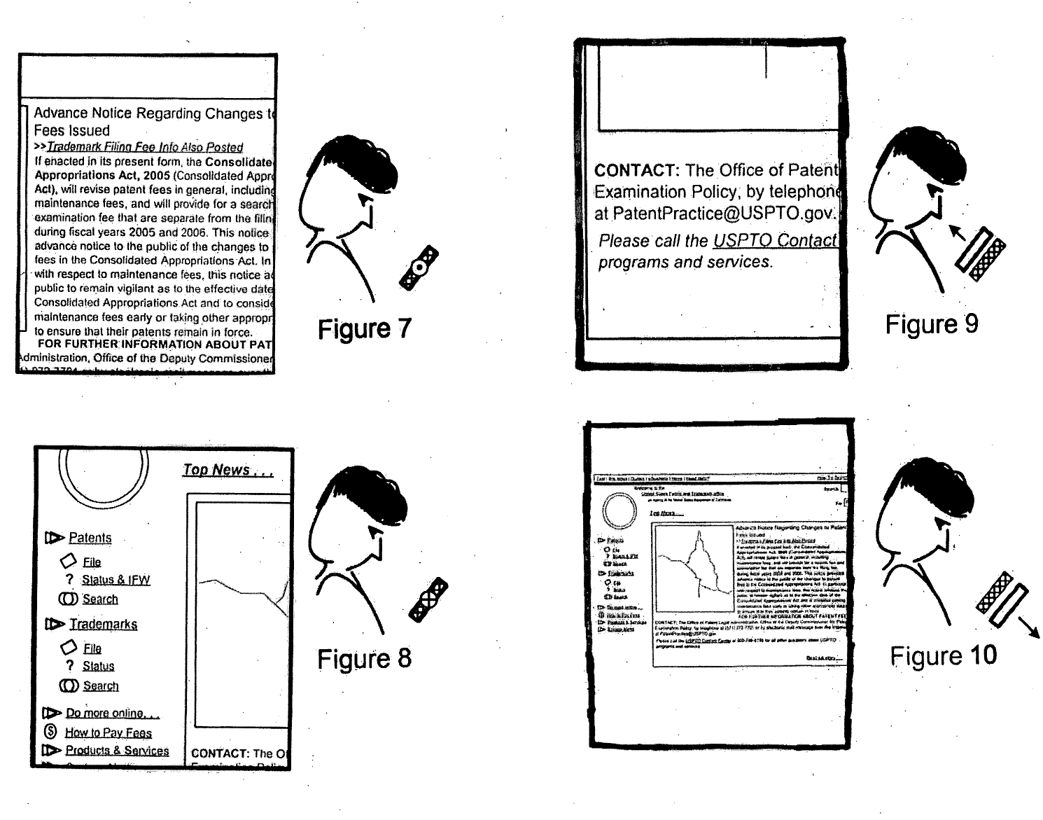

FIG. 6 shows the viewable image portion with the display screen moved down from its starting point. FIG. 7 shows the viewable image portion with the display screen moved to the right of its starting point. In FIG. 7, movement of the display screen outward from the page is indicated by the dot within a circle.

FIG. 8 shows the viewable image portion with the display screen moved to the left of its starting point. In FIG. 8, movement of the display screen is opposite to the movement of FIG. 7 and is indicated by a circle with an “X” inside of it.

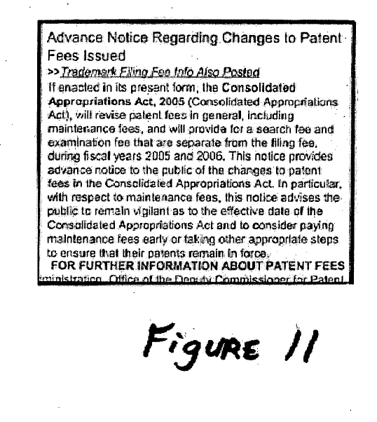

FIG. 9 shows the viewable image portion with the display screen moved inward, or towards the user's viewpoint. In FIG. 9, an inward movement of the display screen causes the image to be zoomed in, or made larger, so that less of the image's area is displayed, but so that the image appears larger. FIG. 10 shows the viewable image portion with the display screen moved outward, or away from the user's viewpoint. In FIG. 10, an outward movement of the display screen causes the image to be zoomed out, or made smaller, so that more of the image's area is displayed, but so that the image appears smaller.

Note that the specific effects upon the viewable image in response to movement of the display can be changed in different embodiments. For example, inward and outward movement of the image can have the opposite effect from that shown in FIGS. 9 and 10. In other words, moving the display screen inward can cause the image to shrink. The specific translations described in FIGS. 4-10 are chosen to be the most intuitive for most users but different applications may benefit from other translations.

A preferred embodiment of the invention uses a translation of a display screen movement to an image movement that is approximately to scale, or 1:1. In other words, a one-centimeter movement of the display acts to reveal one more centimeter of the image in the direction of movement of the display. This calibration provides an intuitive result for a user, much as if they are moving a window over the image. In other embodiments, the scale of correlation of movement of the display to movement of the image can be changed so that, for example, the scale is smaller (i.e., less movement of the image with respect to display movement) or larger (i.e., more movement of the image with respect to display movement). One embodiment contemplates that a user will have a control (e.g., a thumbwheel, pressure sensitive button, voice command, etc.) to be able to adjust the scale of the translation as desired.

Another embodiment allows the user to select two points in space which will correspond to the two opposite diagonal corners of the image or document. The image or document will then be shown in a magnified view corresponding to the ratio of the selected diagonal corners and the size of the device's display. In other words, if a user points and clicks on two points in an image, the two points can be used as opposing corners of a rectangle. The image can then be enlarged or reduced so that the image portion bounded by the defined rectangle is fit to the display screen, or is fit to an arbitrary scale (e.g., 2 times the size of the display screen, etc.).

FIG. 11 illustrates the viewable image portion when the display screen is rotated (e.g., in the direction V of FIG. 1) so that its larger aspect is horizontal instead of vertical as was the case in FIGS. 4-10. Note that the longer horizontal aspect can be better suited for reading text depending on the layout of the text. Allowing the user to easily change the aspect of the display can help in other applications such as when viewing pictures, diagrams, etc.

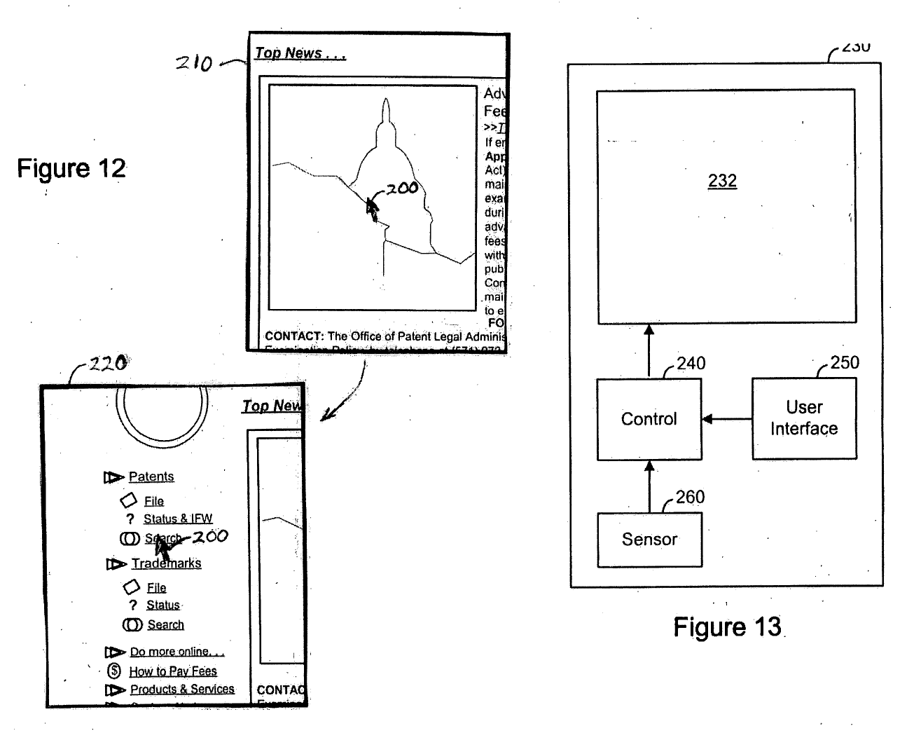

FIG. 12 illustrates selection of an item according to an embodiment of the invention where a stationary screen-centered pointer is used.

In FIG. 12, pointer 200 is initially over text as shown in display 210. As the user moves the display to the left the image is also scrolled to the left so that various hyperlinks become visible. The hyperlink “Search” under “Patents” comes underneath the stationary pointer which remains in the middle of the screen as shown in display 220. When the display is as shown in 220, the user can “select” the “Search” item that underlies the pointer by, e.g., depressing a button on the device. Other embodiments can allow the pointer to move or be positioned at a different point on the screen while selection is being made by moving the display.

Any other suitable action or event can be used to indicate that selection of an item underlying the pointer is desired. For example, the user can use a voice command, activate a control on a different device, keep the item under the pointer for a predetermined amount of time (e.g., 2 seconds), or use any other suitable means to indicate selection.

In one embodiment, selection is indicated by a “shake” of the device. In other words, the user's selection action is to move the device somewhat quickly in one direction for a very short period of time, and then quickly move the device in the opposite direction to bring the device back to its approximate position before the shake movement. The selected item is whatever is underlying (or approximately underlying) the tip of the pointer when the shake action had begun. Other embodiments can use any other type of movement or gesture with the device to indicate a selection action or to achieve other control functions. For example, a shake in a first direction (e.g., to the left) can cause a web browser to move back one page. A shake in the other direction can cause the web browser to move forward one page. A shake up can be selection of an item to which the pointer is pointer. A shake down can toggle the device between modes. Other types of gestures are possible such as an arc, circle, acute or obtuse angle tracing, etc. The reliability of gesture detection and identification depends upon the technology used to sense the movement of the display. Users can create their own comfortable “shakes” or gestures and those can be personalized controls used to indicate direction or position or otherwise control the image viewing experience. Different types of motion sensing are discussed, below.

The “motion mode” of operation (i.e., where a movement of the display screen causes a change in image representation on the screen) can be used together with a “direction control mode” of operation (i.e., where a manipulable control, voice input, or other non-motion mode control, etc.) is used to move a pointer and/or image with respect to the boundaries of the screen. A user can switch between the two modes by using a control, indication or event (e.g., a “shake” movement, voice command, gesture with the device, etc.) or the motion mode can be used concurrently with the direction control mode. For example, the user might use movement of the display to bring an icon into view and then use a thumb joystick control to move the pointer over to the icon with or without additional movement of the display to assist in bringing the desired icon under the pointer, and then make the icon selection. The user may also bring the pointer nearer to one icon than another and in that case the device will, at the user's input via button or other mode, select the closest icon, thus avoiding the need for great precision. Other standalone, serial, or concurrent uses of a motion mode and a directional mode are possible and are within the scope of the invention.

In one embodiment, a user can initiate the motion mode and establish a starting point by, e.g., depressing a control or making a predetermined movement with the device. For example, the user can select a button on the face or side of the device (or elsewhere) that causes the device to establish the current position of the image on the display screen as a starting position from which motion mode will predominate. This is useful, for example, if the user has moved her arm quite far in one direction so that further movement in that direction is impractical or not possible. In such a case, the user can depress a button to suspend motion mode, move her arm back to a central, or comfortable position, and initiate motion mode so that she can continue moving the display in the same direction.

Although both control and motion modes are described, a preferred embodiment of the invention can use the motion mode alone, without additional use of a directional control. Other embodiments can use a combination of a directional control, motion mode and other forms of control for scrolling, panning, zooming, selecting or otherwise manipulating or controlling visual images, icons, menu selections, etc., presented on a display device.

FIG. 13 provides a basic block diagram of a subsystems in an embodiment of the invention.

In FIG. 13, device 230 includes display screen 232, control 240, user interface 250 and position sensor 260. Control 240 can use a microprocessor that executes stored instructions, custom, semi-custom, application specific integrated circuit, field-programmable gate array, discrete or integrated components, microelectromechanical systems, biological, quantum, or other suitable components, or combinations of components to achieve its functions. User interface 250 can include any suitable means for a human user to generate a signal for control 240. Control 240 receives signals from user interface 250 to allow a user to configure, calibrate and control various functions as described herein.

Position sensor 260 can include any of a variety of types of sensors or techniques to determine position or movement of device 230. In one embodiment, micro-gyroscopes are used to determine acceleration in each of the normal axes in space. Gyroscopes such as the MicroGyro1000 manufactured by Gyration, Inc. can be used.

The responses from the gyroscopes are used to determine movement of the device. Movement can be determined from an arbitrary point of reference (e.g., an indicated starting point of the device) or movement can be determined without a specific reference point in space, such as inertial determination of movement. Position sensor 260 can include a laser accelerometer, inertial navigation system, airspeed sensors, etc. Note that any suitable measurement of position, velocity or acceleration can be used to determine device movement.

Relative position sensing can be used to determine device movement. For example, position sensor 260 can include a ranging system such as laser, infrared, optical, radio-frequency, acoustic, etc. In such a case, multiple sensors can be used to determine the device's position in one or more coordinates with one or more reference objects. A distance between the device and the user can be measured, as can the distance from the device to the ground. Movement of the device can be calculated from range changes with the points of reference. Or scene matching or other techniques can be used to determine that a reference object is being traversed as the device is moved. For example, an approach similar to that used in an optical mouse can be used to determine transversal movement of the device.

Another way to sense position is to use a Global Positioning System (GPS) receiver. Although today's commercially available GPS service is not accurate enough to be suitable for determining human hand movements, a system that is similar to GPS can be implemented in localized areas (e.g., within a room, within a few blocks, within a city, etc.) and can be used to provide high-resolution position signals to enable the device to determine its position.

Triangulation of two or more transmitters can be used. For example, a radio-frequency, infrared or other signal source can be worn by a user, or attached to structures within a room or within an operating area. A receiver within the device can use the signals to determine position changes.

Other approaches to position sensing are possible such as those provided by MEMS devices, organic sensors, biotechnology, and other fields. In some applications, sensitive position or movement sensing may not be required and approaches using switches (e.g., inertial, mercury, etc.), or other coarse resolution solutions can be sufficient.

A translation process (not shown) is used to convert position or movement information from sensor 260 into a movement of an image on display screen 232. In a preferred embodiment, control 240 accepts sensor data and performs the translation of movement of the device into panning, scrolling, zooming or rotation of an image on the display screen. However, other embodiments can achieve the translation function by any suitable means. For example, the translation processing can be done in whole or in part at sensor 260 or control 240 or other subsystems or components (not shown) in device 230. Yet other embodiments can perform position or movement sensing externally to device 230 (e.g., where an external video camera detects and determines device movement) and can also perform the translation computation external to the device. In such a case, the results (or intermediate results) of the translation can be transmitted to the device for use by control 240 in changing the display.

Although embodiments of the invention have been described primarily with respect to devices that include a display screen, a display screen alone can be provided with features according to embodiments of the invention. In other words, a display screen by itself, or a device that only includes a display screen (or primarily includes a display screen) can be provided with a motion mode of operation. Any type of display technology can be used with features of the invention. For example, something as large as a projection display, stereo (three dimensional) display, or as small as a mouse or eyeglass display can be used. In the latter case, the user could control the image viewing experience with head movements that are detected. This could be particularly useful for applications requiring hands free operation or for handicapped persons who don't have use of their hands.

Not all movements in all axes as presented herein need be used in any particular embodiment. For example, one embodiment might just allow panning or zooming that in response to a movement of the display in one or more directions.

Although embodiments of the invention are discussed primarily with respect to a specific device such as a mobile phone or PDA, any other type of device that can be moved in space can benefit from features of the invention. For example, a handheld device or a device light enough to be carried or held by a person, or people, can be provided with functionality as described herein. Larger or heavier devices may advantageously be moved with the aid of a machine or apparatus, or with a combination of both manual and automated movement, and the movement detected and used to change the display. For example, a display screen can be mounted to a surface by a movable arm, or affixed to a bracket that allows movement of the display by a user.

In general, any type of motion of a display screen can be translated into a corresponding change in the display of an image on the display. For example, types of movements that are a combination of the movements discussed herein can be used. Other movements that are different from those presented previously are possible such as tilting, shaking, etc. Such movements may be used to advantage in different embodiments such as where a quick shake serves to back up to a previously viewed image, causes a rapid scrolling in a predetermined direction, acts as a mouse click, etc.

Any type of image or image information can be displayed and manipulated. For example, hyperlinks, icons, thumbnails, text, symbols, photographs, video, three-dimensional images, computer-generated images, or other visual information, can all be the subject of motion mode manipulation.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. An apparatus for manipulating an image, the apparatus comprising:
a display screen coupled to a housing;
a sensor coupled to the housing, wherein the sensor provides information on a movement of the display screen;
a translation process for translating a signal from the sensor into a change in an image displayed on the display screen.

2. The apparatus of claim 1, wherein the sensor includes a position sensor.

3. The apparatus of claim 1, wherein the sensor includes a velocity sensor.

4. The apparatus of claim 1, wherein the sensor includes an acceleration sensor.

5. The apparatus of claim 4, wherein the acceleration sensor includes a gyroscope.

6. The apparatus of claim 5, wherein the sensor includes a microelectromechanical system.

7. The apparatus of claim 1, wherein the translation process converts a right-to-left movement of the display screen into a corresponding right-to-left movement of the image.

8. The apparatus of claim 1, wherein the translation process converts an upward movement of the display screen into a corresponding upward movement of the image.

9. The apparatus of claim 1, wherein the translation process converts an inward movement of the display screen into a corresponding zoom of the image.

10. The apparatus of claim 1, further comprising:
a user input control for putting the device in a motion mode of operation, wherein in the motion mode of operation the translation process is operable to change the image on the display screen in response to a movement of the display screen, and wherein in a non-motion mode of operation the translation process is not operable to change the image on the display screen in response to a movement of the display screen.

11. The method of claim 1, wherein a predetermined direction of movement is not translated into a change in the image.

12. The method of claim 11, wherein the image includes column-formatted text, wherein the direction of movement not translated includes horizontal movement.

14. The method of claim 1, wherein a movement is extrapolated into a continued change in the image.

15. The method of claim 1, wherein the image includes a map, wherein the continued change in the image includes continued scrolling in a direction that was previously indicated by a direction of movement.

16. The method of claim 1, wherein the housing includes a mouse input device.

17. The method of claim 16, wherein the change in the image on the display screen is constrained in a direction of movement.

18. A method for manipulating an image on a display screen, the method comprising:
determining a movement in space of the display screen; and
changing the image on the display screen in accordance with the movement in space of the display screen.

19. The method of claim 18, wherein determining a movement in space of the display screen is performed at least in part by an apparatus separate from the display screen.

20. A machine-readable medium including instructions executable by a processor for manipulating an image on a display screen, the machine-readable medium comprising:
one or more instructions for determining a movement in space of the display screen; and
one or more instructions for changing the image on the display screen in accordance with the movement in space of the display screen.
